(19) United States
(12) Patent Application Publication
(10) Pub. No.: US 2025/0299524 A1
(43) Pub. Date: Sep. 25, 2025

(54) FILLING APPARATUS AND METHOD FOR FILLING CONTAINERS WITH DOCUMENTS OF VALUE

(71) Applicant: GIESECKE+DEVRIENT CURRENCY TECHNOLOGY GMBH, Munchen (DE)

(72) Inventor: Markus SPERL, Straubing (DE)

(21) Appl. No.: 18/860,401

(22) PCT Filed: Apr. 27, 2023
(86) PCT No.: PCT/DE2023/100307

§ 371 Date: Oct. 25, 2024

(30) Foreign Application Priority Data
May 3, 2022 (DE) 10 2022 001 543.9

(51) Int. Cl. G07D 11/16; B65H 31/30

(52) U.S. Cl. CPC G07D 11/16; B65H 31/3045; B65H 2301/422548; B65H 2701/1912

(57) ABSTRACT

A filling apparatus and to a method are for filling containers with document-of-value stacks, and to a document-of-value processing apparatus. The filling apparatus is designed for filling containers with document-of-value stacks, for example document-of-value stacks that are set down by a document-of-value processing machine in a delivery region of the document-of-value processing machine. The filling apparatus has a feed interface, a delivery interface and a transport path along which the containers can be transported from the feed interface to the delivery interface, and a filling region in which in each case one container that has been fed to the filling apparatus can be positioned in order to be filled with document-of-value stacks by means of a gripping device.

The invention relates to a filling apparatus and to a method for filling containers with documents of value, in particular banknotes, and to a document-of-value processing apparatus having such a filling apparatus.

In so-called cash centers, for example at value transport companies or central banks, in which large numbers of documents of value are checked, sorted, counted and optionally banded together by means of document-of-value processing machines. For the purposes of storage and/or transport, the documents of value processed in this way are commonly introduced into document-of-value containers provided for the same at the cash center.

In document-of-value processing machines, the documents of value are individually withdrawn from a stack and are guided on a transport path past sensors. The individual documents of value are checked by the sensors and, in accordance with the result of the check, are fed to particular destinations within the apparatus, for example delivery compartments. The checked documents of value are fed, in the apparatus, to the stacking wheel and are received in the compartments thereof, which are arranged one behind the other in spiral fashion around an axis of rotation. The stacking wheel rotates such that the compartments are filled with documents of value. The documents of value are swept out of the compartments of the stacking wheel by a sweeping means and a stack is thus formed, which is delivered out of the apparatus.

It is also known for a document-of-value stack that has been delivered in a delivery compartment of a document-of-value processing machine to be removed from the delivery compartment, and introduced into a document-of-value container, by means of a gripper. For this purpose, the container is transported along a transport path to the banknote processing apparatus and is placed in the vicinity of the delivery compartment. A disadvantage here is that each container, after being filled with document-of-value stacks, is returned again from the document-of-value processing machine on the same transport path. Therefore, to fill a further container, it is necessary to wait until the first container has been removed.

It is an object of the present invention to speed up the filling of containers with documents of value, in particular banknotes.

This object is achieved by means of the filling apparatus and the filling method according to the independent claims.

The filling apparatus is designed for filling containers with document-of-value stacks, for example document-of-value stacks that are set down by a document-of-value processing machine in a delivery region of the document-of-value processing machine.

The containers to be filled each have one or more receiving sections which are each designed to receive one document-of-value stack. The containers or receiving sections are preferably open at the top side thereof, such that document-of-value stacks can be introduced into the containers from above. The receiving sections may be separated from one another by separating elements, which may be integral with the container or may be elements which are separate from the container and which can be positioned variably in the container. The document-of-value stacks are commonly introduced into the container or into the receiving sections thereof such that the documents of value stand on their edges in the container.

The filling apparatus has a feed interface, in particular feed opening, by means of which the containers that are to be filled with document-of-value stacks are fed (individually in succession) to the filling apparatus. Said containers may be fed manually or automatically in this case. The filling apparatus furthermore has a delivery interface, in particular delivery opening, by means of which the containers that have been filled with document-of-value stacks are, after being filled, delivered (individually in succession) out of the filling apparatus.

The filling apparatus furthermore has a transport path along which the containers can be transported from the feed interface to the delivery interface, and a filling region which is arranged between the feed interface and the delivery interface in relation to the transport path of the containers and in which in each case one container that has been fed to the filling apparatus (and which is to be filled) can be positioned in order to be filled there with document-of-value stacks.

For the transport of the containers through the filling apparatus, the filling apparatus has at least one transport device which is designed to transport a container that is fed to the filling apparatus for filling purposes from the feed interface along the transport path to the filling region and thus position said container in the filling region, and which is designed to transport the filled container (after the filling operation) further along the transport path from the filling region to the delivery interface of the filling apparatus. A control device of the filling apparatus is designed to control the transport of each container by means of the transport device along the transport path, in particular from the feed interface to the filling region and onward from the filling region to the delivery interface.

Furthermore, the filling apparatus or the document-of-value processing machine may have a gripping device which is configured to grip a (in each case one) document-of-value stack, in particular a document-of-value stack that has been set down in the delivery region of the document-of-value processing machine, to remove said document-of-value stack from the delivery region, and to set down said document-of-value stack in a receiving section of a container positioned in the filling region of the filling apparatus, in order to fill the container with the document-of-value stack (and optionally further document-of-value stacks). The aforementioned control device of the filling apparatus may be designed to control the setting-down of the document-of-value stack in the container by means of the gripping device and optionally the gripping of the document-of-value stack that has been set down in the delivery region. This controlling of the gripping device may however also be performed by means of a further control device, in particular a gripper controller, which is provided specifically for the gripping device and which may be part of the filling apparatus.

By virtue of the fact that the containers are transported in the filling apparatus along the transport path from the feed interface to the filling region and then onward from the filling region to the delivery interface, it is achieved that the next container to be filled can already be transported toward the filling region whilst the previously filled container is simultaneously being transported away from the filling region. It is therefore not necessary to wait until the previously filled container has been transported away before the next container to be filled is transported in. Altogether, the invention therefore makes it possible for multiple containers in succession to be filled with document-of-value stacks more quickly.

For example, the document-of-value processing machine has, in the delivery region, a setting-down platform on which the document-of-value stacks that are delivered by the document-of-value processing machine are set down by the document-of-value processing machine, in particular by a stacking wheel of the document-of-value processing machine, in order to be removed by means of the gripping device. Alternatively, the document-of-value stack may also be set down by a mobile platform arranged under the setting-down platform and removed from there by means of the gripping device.

The filling apparatus may have a housing or a paneling which surrounds the transport path of the containers. The feed interface and delivery interface are preferably in the form of a feed opening and a delivery opening in the housing or in the paneling of the filling apparatus. Alternatively, the filling apparatus may however also be implemented without a housing or paneling, and the feed interface and delivery interface may correspondingly not be in the form of openings. For example, the start and the end of the transport path may form the feed interface and the delivery interface respectively.

The control device of the filling apparatus is preferably designed to control the transport device such that a container that is to be filled remains temporarily in the filling region until the gripping device has set down multiple document-of-value stacks into multiple receiving sections of the container. In particular, the control device and/or the further control device is designed to control the gripping device and optionally the transport device such that the gripping device, when filling the container, fills each receiving section of each container with (only) exactly one document-of-value stack.

The container may have at least two receiving sections along its longitudinal direction, and the control device and/or the further control device may be designed to control the gripping device and optionally the transport device such that multiple document-of-value stacks that have been delivered by the document-of-value processing machine (that is to say set down for example in succession in the same delivery compartment, for example on a setting-down platform or mobile platform) are set down in succession into different receiving sections of the same container positioned in the filling region.

The control device may be designed to control the transport device such that in each case (exactly) one receiving section of a container positioned in the filling region is arranged in a predetermined filling position in the filling region, said filling position being situated within the filling region, and to control the transport device such that each container positioned in the filling region is transported incrementally along a transport direction by means of the transport device such that different (for example two or more) receiving sections of the same container are arranged in succession at the predetermined filling position and remain there temporarily until the gripping device has set down in each case one document-of-value stack in the relevant receiving section of the container. In particular, the control device may control the transport device such that each container stops, in order for the relevant document-of-value stack to be introduced, as soon as that receiving section of the container into which the relevant document-of-value stack is to be introduced is situated at the filling position. By virtue of the different receiving sections being arranged in succession at the predetermined filling position, it is possible to use a technically simple gripper, because this only needs to be moved to the determined filling position and does not need to perform any translational movement along a along the longitudinal direction of the container.

The control device or the further control device may be designed to control the gripping device such that it sets down a document-of-value stack in the relevant receiving section whilst the relevant receiving section, which is to be filled, of the container that is to be filled is or remains (temporarily) at the predetermined filling position.

If the document-of-value stacks are always introduced into the relevant container at the same filling position, it is achieved that the gripping device can always set down the document-of-value stacks at the same location (at the predetermined filling position). Therefore, to set down the document-of-value stack, it is merely necessary to perform a pivoting movement and a translational movement along a single direction (in order to introduce the document-of-value stack into the container and optionally in order to remove the document-of-value stack from the document-of-value processing machine), but no additional translational movement along a second direction that is directed along the container. A simpler gripping device can thus be used.

For example, the transport device has at least one first and at least one second transport device, wherein the at least one first transport device is designed to transport a container that is fed to the filling apparatus for filling purposes from the feed interface along the transport path to the filling region (and thus to position said container in the filling region), and the at least one second transport device is designed to transport the filled container, after the filling operation, further along the transport path from the filling region to the delivery interface of the filling apparatus. The at least one first transport device is arranged upstream of the filling region along the transport path and is designed merely to transport the container (coming from the feed interface) toward the filling region, and not to transport the container away from the filling region (in the direction of the delivery interface). The at least one second transport device is arranged downstream of the filling region along the transport path and is designed merely to transport the container away from the filling region (in the direction of the delivery interface), and not to transport the container (coming from the feed interface) toward the filling region. It would alternatively be possible for both transport operations to be implemented using one single transport device (for example a T or conveyor belt), optionally with curve(s), and a stopper for stopping items at the filling position.

The transport device, in particular the at least one first transport device, is preferably configured to transport each container away from the feed interface (out of the feed interface) along a feed transport direction toward the document-of-value processing machine in order to collect said container from the feed interface. The transport device, in particular the at least one second transport device, is also preferably configured to transport each container along a delivery transport direction (away from the document-of-value processing machine) toward the delivery interface (into the delivery interface) in order to make said container available for collection in the delivery interface.

The transport direction of the container within the filling apparatus, along which transport direction the container is transported in order for different receiving sections of the container to be arranged in succession at the filling position, preferably runs parallel to the longitudinal direction of the container along which the receiving sections of the container are arranged. In particular, the feed transport direction and the delivery transport direction of the container run parallel to the longitudinal direction of the container along which the receiving sections of the container are arranged.

In particular, the transport path of the containers in the filling apparatus has a feed section, which extends from the feed interface to the filling region and optionally has various subsections, and a delivery section, which extends from the filling region to the delivery interface and optionally has various subsections. The feed section and the delivery section are in particular arranged in the filling apparatus so as to be mutually separate, or so as not to overlap one another. Each container is transported by means of the transport device over the feed section and over the delivery section to the delivery interface. In particular, each container is transported along the feed transport direction over the feed section, or over a first subsection of the feed section that begins at the feed interface, and is transported along the delivery transport direction over the delivery section, or over a final subsection of the delivery section, to the delivery interface. The delivery transport direction preferably runs substantially oppositely to the feed transport direction. This results in a compact construction of the filling apparatus.

Preferably, the feed section has, along the transport path or along the feed transport direction, at least the length of the container(s) to be filled, and/or the delivery section has, along the transport path or along the delivery transport direction, at least the length of the container(s) to be filled. It is thus achieved that the next container to be filled can be temporarily stored in the feed section whilst the preceding container is still being filled, or that the filled container can be transported onward into the delivery section and temporarily stored there whilst the next container to be filled is already being transported in the filling region. The feed section then forms a type of buffer store for the containers to be filled, allowing the next container to be fed to the filling apparatus at an early point in time whilst the preceding container is still being filled. Also, the delivery section then forms a type of buffer store for the filled containers, allowing the filled container to later be collected or removed from the filling apparatus whilst the preceding container is already being filled. An operator of the filling apparatus therefore does not need to feed and remove the containers exactly at the points in time specified by the filling apparatus, but is provided with flexibility with regard to the timing of the feeding and removal of the containers.

The filling region preferably has an input side, at which the feed section ends, and an output side, which differs from (for example is situated opposite) the input side and at which the delivery section begins.

In particular, the containers to be filled are transported on the feed section by the filling apparatus only before said containers are filled (not after they have been filled), and the containers filled with document-of-value stacks are transported on the delivery section by the filling apparatus only after said containers have been filled (not before they are filled). The next container to be filled can be positioned at the input side of the filling region already whilst the preceding container is simultaneously being filled, and the next container can already be transported into the filling region at the same time as the container that has just been fully filled is being transported away; in other words, to introduce the container that is to be filled into the filling region, it is not necessary to wait until the previously filled container has been transported away. A particularly high throughput is thus achieved when filling containers by means of the filling apparatus.

Preferably, the feed section or at least a subsection of the feed section, in particular its first subsection that begins at the feed interface, is arranged so as to be vertically and/or horizontally offset, and in particular directly adjacent, with respect to the filling region and/or with respect to the delivery section or with respect to at least a subsection of the delivery section, in particular with respect to that subsection of the delivery section which ends at the delivery interface. Good operability of the filling apparatus is thus achieved, because an operator can, in the same working step, feed a container that is to be filled to the filling apparatus and collect a filled container from the filling apparatus.

The transport directions of the container in the feed section and in the delivery section preferably run at least in part oppositely and parallel to one another. This results in a compact construction of the filling apparatus. In particular, the feed section or at least a subsection of the feed section, in particular the first subsection that begins at the feed interface, and the delivery section or at least a subsection of the delivery section, in particular that subsection of the delivery section which ends at the delivery interface, run parallel to one another (with opposite transport directions).

In some exemplary embodiments, the transport path of the containers in the filling apparatus has a connecting section in which the transport direction of the container runs transversely or perpendicularly with respect to the feed transport direction and/or with respect to the delivery transport direction of the container. The connecting section may be a subsection of the feed section or a subsection of the delivery section. The transport direction of the container in the connecting section runs in particular along the front side of the document-of-value processing machine, for example along the operator-facing side thereof.

In some exemplary embodiments, the transport path of the containers from the feed interface to the delivery interface runs continuously substantially horizontally. The containers can then be transported more easily, because no transport device for vertical transport is required. The feed section and the delivery section are situated for example horizontally adjacent to one another, and the transport directions of the container in the feed section and in the delivery section run at least in part oppositely and parallel to one another.

The transport path of the containers in the filling apparatus may be designed such that the containers are diverted twice, preferably through a total of 180°, for example twice (either horizontally or vertically) through 90°, on their transport path from the feed interface to the delivery interface.

The filling region may in particular be situated on the return path of the container from the document-of-value processing machine to the delivery interface, or at the start of this return path, or may be situated on the forward path from the feed interface to the document-of-value processing machine, or at the end of this forward path. The start of the return path or the end of the forward path may be situated at the closest point of the transport path to the document-of-value processing machine, for example in the connecting section.

In one exemplary embodiment, the filling region is arranged downstream of the connecting section along the transport path, and the filling region is situated on the return path of the container from the document-of-value processing machine to the delivery interface. The containers are diverted horizontally through 90° twice in succession on the feed section between the feed interface and the filling region.

In another exemplary embodiment, the filling region is arranged upstream of the connecting section along the transport path, and the filling region is situated on the forward path of the container from the feed interface to the document-of-value processing machine. The containers are diverted horizontally through 90° twice in succession on the delivery section between the filling region and the delivery interface.

In further exemplary embodiments, the feed section and the delivery section are at least in part situated vertically one above the other, and the transport directions of the container in the feed section and in the delivery section run at least in part oppositely and parallel to one another. The filling apparatus then advantageously has a small space requirement in a lateral direction, that is to say at the operator-facing side of the document-of-value processing machine. The filling region is preferably arranged in the upper region of the filling apparatus, which upper region is situated above the delivery section and feed section.

In one of the further exemplary embodiments, at least a subsection of the feed section, which is situated in the lower region of the filling apparatus, is situated under the delivery section, and the transport direction in this subsection of the feed section runs oppositely and parallel to the transport direction in the delivery section. Also, a connecting section of the feed section, in which the transport direction of the container runs vertically or obliquely upward, connects the lower and the upper region of the filling apparatus. The filling region and the delivery section are situated in the upper region of the filling apparatus.

In one of the further exemplary embodiments, the feed section and the filling region are situated in the upper region of the filling apparatus, and at least a connecting section of the delivery section, in which the transport direction of the container runs vertically or obliquely downward, connects the upper and the lower region of the filling apparatus. Also, a subsection of the delivery section which follows said connecting section is situated in the lower region of the filling apparatus, under the feed section, and the transport direction of said subsection runs oppositely and parallel to the transport direction in the feed section.

In order to be able to grip document-of-value stacks of considerably different size and introduce the same into the container, different opening widths of the gripping device may be provided for the moving-apart of the gripping elements of the gripping device.

If different container types are used, the receiving section(s) of which are situated in different positions along the longitudinal direction of the container and/or have different lengths, the control device or the further control device may have information relating to the predetermined position and optionally length of the receiving sections based on the container type. The information relating to the container type of the container that is to be filled in each case may be preset at the filling apparatus or may be input by an operator (optionally on a container-specific basis) or may be ascertained automatically by the control device or the further control device on the basis of identification data of the container (optionally on a container-specific basis). The control device then controls the opening width of the gripping elements in accordance with the container type and optionally in accordance with the receiving section that is to be filled in each case (if the container type has receiving sections of different, known sizes).

The control device or the further control device may be designed to ascertain receiving section information relating to the receiving sections of the container that is to be filled in each case, said information concerning in particular the position and/or the length of the receiving sections along the container. The length corresponds, for example, to a maximum number of documents of value that can be received in the particular receiving section. Said control device or further control device may ascertain the receiving section information for example on the basis of identification data of the container or on the basis of the position of the receiving sections or separating elements as ascertained by a sensor of the filling apparatus or on the basis of container information provided by the operator of the filling apparatus.

The control device or the further control device may be designed to transmit the receiving section information of each container (optionally on a container-specific basis) to the document-of-value processing machine, from the delivery region of which the document-of-value stack is removed. The document-of-value processing machine of the document-of-value processing apparatus may in particular be configured to control the quantity, in particular the maximum number, of documents of value that it sets down in the document-of-value stack for the particular receiving section of the particular container, said document-of-value stack being set down in the delivery region of the document-of-value processing machine, in accordance with the receiving section information transmitted by the filling apparatus and relating to the particular receiving section.

Alternatively or in addition, the control device or the further control device may be designed to control an opening width of gripping elements of the gripping device in accordance with the receiving section information item during the gripping of the document-of-value stack, in particular during the removal of the document-of-value stack from the document-of-value processing machine and/or during the introduction of the document-of-value stack into the container. Here, the gripping device may be actuated such that its gripping elements assume different opening widths for different receiving sections and/or for different container types.

In order to be able to ascertain the receiving section information, the filling apparatus may have at least one read device for determining identification data of each container (said read device being arranged for example at the feed section for the containers or being a manually operable barcode reader), and the control device/the further control device may have information relating to the position and optionally length of the receiving sections based on the identification data (for example a table) and be designed to ascertain the receiving section information of each container on the basis of the identification data of the container that is to be filled in each case, and/or may have a sensor which is arranged at the feed section of the filling apparatus such that, when a container is situated in the feed section, said sensor can determine the position of the receiving sections or of separating elements that divide the container into receiving sections, and the control device/the further control device may be designed to ascertain, on the basis of the position of the receiving sections or separating elements as determined by the at least one sensor, receiving section information relating to the container that is to be filled in each case, and/or may receive information relating to the container type of the container(s) to be filled (said information being presettable by the operator of the filling apparatus, for example for multiple containers), wherein the position and length of the receiving sections are identical and predetermined for all containers of the same container type, and the control device/the further control device has information relating to the predetermined position and optionally length of the receiving sections based on the container type (for example a table) and is designed to ascertain receiving section information of the container based on the container type of the container that is to be filled in each case.

The invention also relates to a method for filling containers with document-of-value stacks by means of a filling apparatus, in particular by means of the filling apparatus described above, wherein the filling apparatus has a feed interface (for example feed opening) by means of which the containers that are to be filled with document-of-value stacks can be fed (individually in succession) to the filling apparatus, a delivery interface (for example a delivery opening), a transport path along which the containers can be transported from the feed interface to the delivery interface, a filling region which is arranged between the feed interface and the delivery interface in relation to the transport path of the containers, and at least one transport device which is designed to transport a container that is fed to the filling apparatus for filling purposes from the feed interface along the transport path to the filling region, and to transport said container (after the filling operation) further along the transport path from the filling region to the delivery interface of the filling apparatus. In the method, the following steps are carried out:
feeding a container to the feed interface of the filling apparatus,
transporting the fed container by means of the transport device of the filling apparatus from the feed interface along the transport path to the filling region of the filling apparatus,
filling the container positioned in the filling region with at least one document-of-value stack by means of a gripping device which is configured to grip a (in each case one) document-of-value stack and to set down the gripped document-of-value stack in a receiving section of a container positioned in the filling region of the filling apparatus, in order to fill the container with the document-of-value stack and optionally further document-of-value stacks,
transporting the container filled with at least one document-of-value stack from the filling region to the delivery interface of the filling apparatus by means of the transport device in order to deliver the containers filled with document-of-value stacks out of the filling apparatus (individually in succession) through the delivery interface.

The gripping device may be part of the filling apparatus or part of the document-of-value processing machine, or may be an apparatus that is separate from these two, for example a robot gripper. The gripping device may be configured to remove the document-of-value stack(s) (to be gripped) from a document-of-value processing machine, in particular from a delivery region of the document-of-value processing machine, in which the (particular) document-of-value stack has been set down. Alternatively or in addition, the gripping device may be configured to remove the document-of-value stack(s) to be gripped from another storage place where the document-of-value stack has been set down, or from another container in which the document-of-value stack to be gripped is contained.

The invention also relates to a document-of-value processing apparatus for processing documents of value, in particular banknotes. The document-of-value processing apparatus has a document-of-value processing machine for processing, in particular checking and optionally sorting, documents of value, said document-of-value processing machine being configured to deliver document-of-value stacks of processed documents of value in a delivery region of the document-of-value processing machine, and optionally to set down said document-of-value stacks in the delivery region. The document-of-value processing apparatus furthermore has one or more of the above-described filling apparatuses, which is/are configured for filling containers with the document-of-value stacks that have been delivered out of the document-of-value processing machine. Said filling apparatus(es) may be moved against and/or docked to and/or fastened to the document-of-value processing machine.

For example, the documents of value are banknotes, though the invention relates to any type of documents of value.

Further advantages, features and possible uses of the present invention will become apparent from the following description in conjunction with the figures, in which:

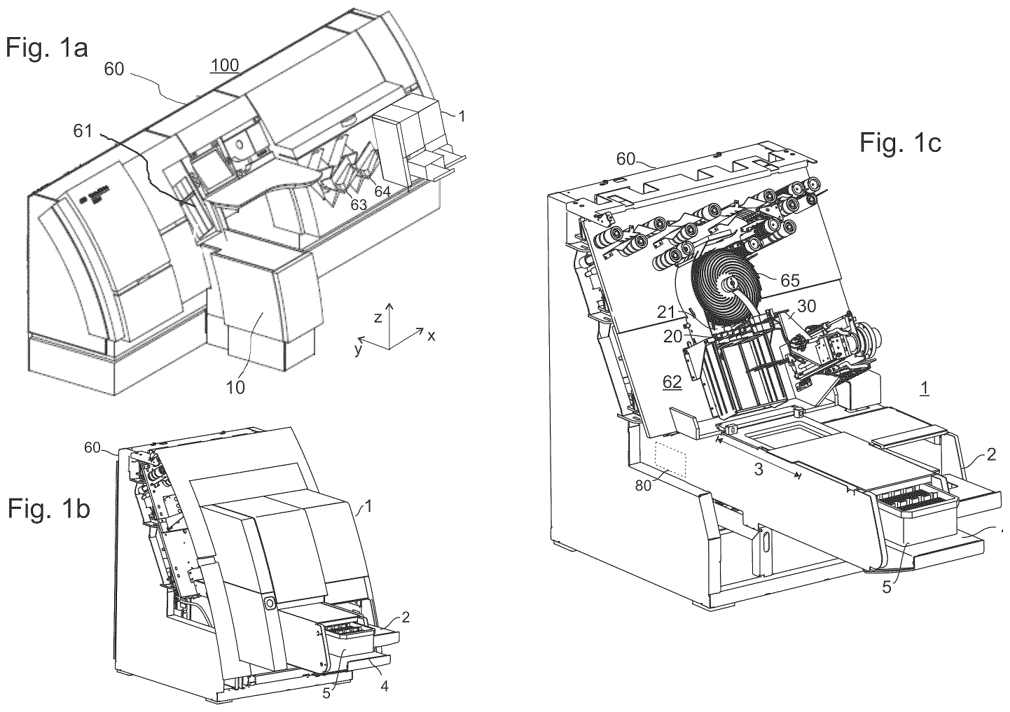

FIG. 1a shows an exemplary embodiment of a document-of-value processing apparatus having a document-of-value processing machine and a filling apparatus,

FIGS. 1b-c show detail views of the document-of-value processing apparatus in the region of the filling apparatus with covers (FIG. 1b) and without covers (FIG. 1c),

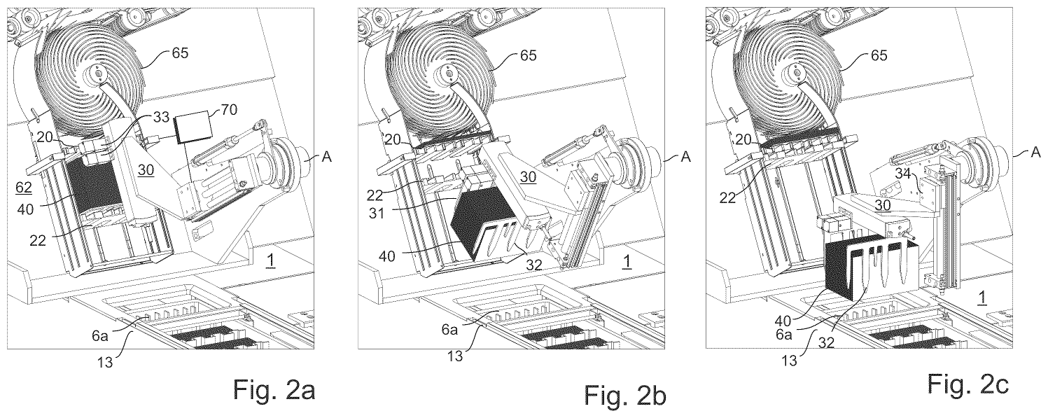

FIGS. 2a-c show the transport of a document-of-value stack from the document-of-value processing machine to the filling apparatus by means of a gripping device of the filling apparatus,

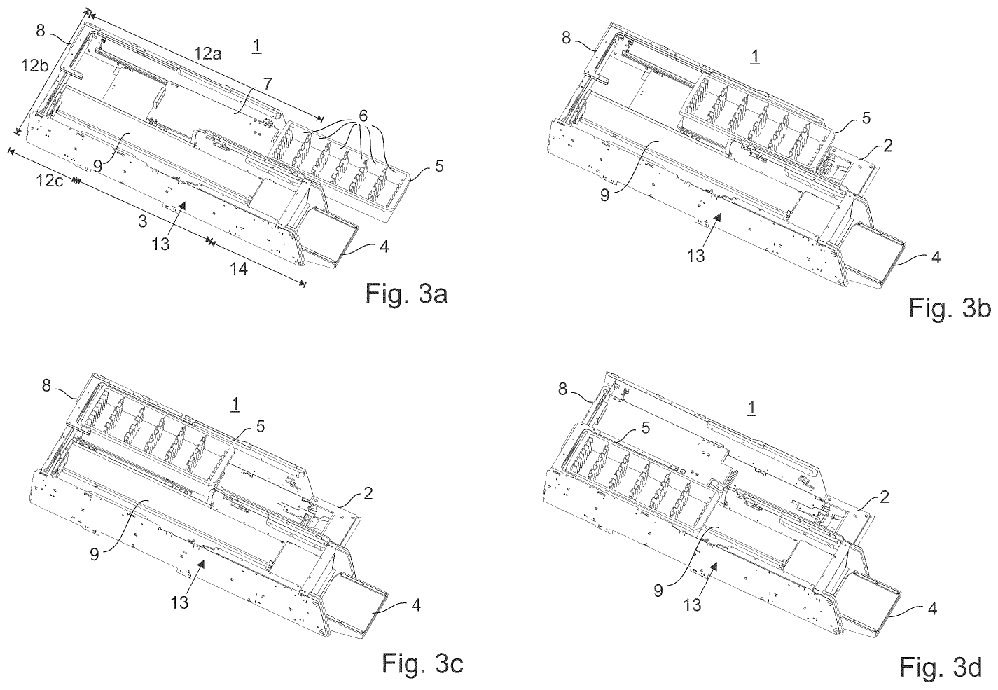

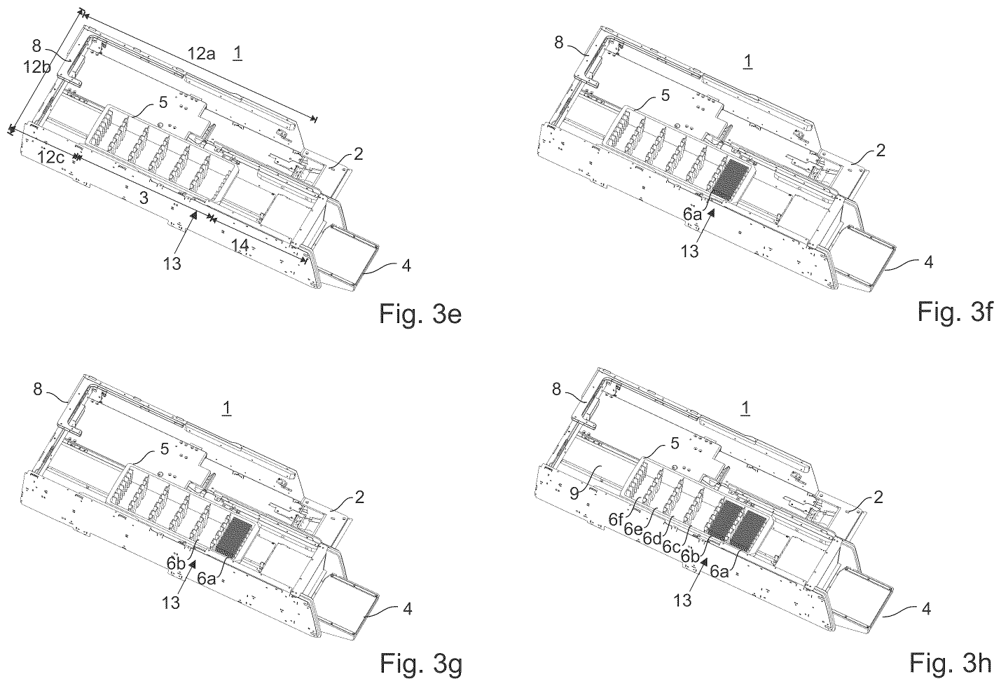

FIGS. 3a-h show an incremental horizontal movement of a banknote container through the filling apparatus of the exemplary embodiment of FIGS. 1-2 and the introduction of banknote stacks into said banknote container, and

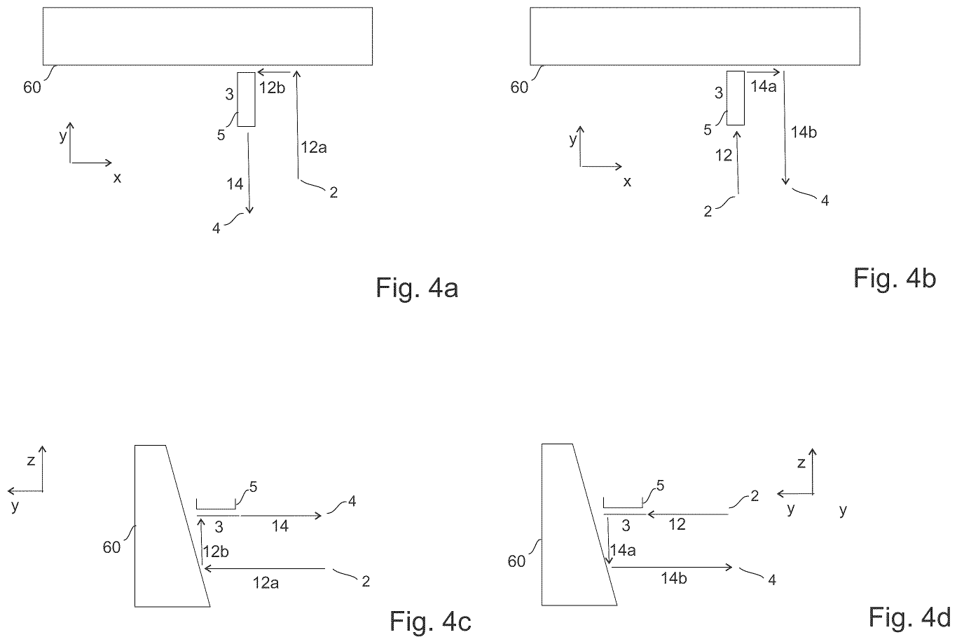

FIGS. 4a-d show four further exemplary embodiments of filling apparatuses having differently running transport paths of the containers, in a plan view (FIGS. 4a and 4b) and in a side view (FIGS. 4c and 4d).

FIG. 1a shows a document-of-value processing apparatus 100 according to an exemplary embodiment. The document-of-value processing apparatus 100 has a document-of-value processing machine 60 for processing documents of value, in particular for sorting, counting and/or checking the documents of value, said document-of-value processing machine being configured to make processed documents of value available to the filling apparatus 1, or optionally to deliver said documents of value into one of its delivery compartments 63, 64. The documents of value may be introduced into the input compartment 61 of the document-of-value processing machine 60 automatically by means of an introduction module 10, in which documents of value are removed, in stacks, from document-of-value containers. The document-of-value processing apparatus 100 is used for example in a cash center.

The banknotes introduced into the input compartment 61 of the document-of-value processing machine 60 are drawn individually out of the input compartment by a separating means and, in the document-of-value processing machine 60, are transported along a transport path past one or more sensors (not shown). Here, physical properties of the documents of value are detected and converted into corresponding sensor signals, which are used by a control and evaluation device of the document-of-value processing machine 60 to identify and check the documents of value, for example with regard to quality, denomination, authenticity or condition. Switches arranged along the transport path are controlled such that the documents of value are transported, in accordance with the result of the identification or check, to different delivery compartments 63, 64 or to the filling apparatus 1, in which said documents of value are automatically introduced into document-of-value containers. The delivery compartments 63, 64 may for example be followed by a banding device and/or packaging device for the document-of-value stacks that have been formed.

The documents of value transported to the filling apparatus 1 may for example be reject documents of value which have been rejected by the apparatus 60 during the checking operation, whereas documents of value that have been accepted during the checking operation are set down into the delivery compartments 63, 64. It is however alternatively also possible for banknotes that have been accepted during the checking operation to be transported to the filling apparatus 1. It is also possible for multiple filling apparatuses 1 to be installed on one document-of-value processing machine 60.

In each case one stacking wheel 65 is situated in the document-of-value processing machine 1 upstream of the delivery compartments 63, 64 and in a delivery region 62, positioned upstream of the filling apparatus 1, of the document-of-value processing machine 60, by means of which stacking wheel the banknotes are stacked for the delivery thereof. In the delivery region 62, positioned upstream of the filling apparatus 1, of the document-of-value processing machine 60, a setting-down platform 20, cf. FIG. 1c, is situated under the stacking wheel 65, on which setting-down platform banknotes, for example, are stacked by the stacking wheel 65 to form a banknote stack. In the example shown, after the banknote stack has been fully formed, the setting-down platform 20 is retracted rearwardly into the apparatus 60 in order for the banknote stack to be swept off against a rear wall 21 situated behind the setting-down platform 20 and thus set down from the setting-down platform 20 onto a movable mobile platform 22 arranged under said setting-down platform.

The banknote stack 40 thus formed is then moved downward by means of the mobile platform 22 and thus made available for removal by a gripping device 30 of the filling apparatus 1, cf. FIGS. 2a-c. It is however alternatively also possible for the setting-down platform 20 itself to be downwardly movable in order to make the banknote stack 40 available for removal by the gripping device 30 of the filling apparatus 1 (with no mobile platform 22 being required).

The filling apparatus 1 is used for filling document-of-value containers 5 with the banknote stacks 40 that are made available in the delivery region 62 of the apparatus 60. For this purpose, an (empty or partially filled) document-of-value container 5 that is to be filled is fed manually or automatically to the filling apparatus at its feed interface 2 in the form of a feed opening, cf. FIG. 1c. The container 5 is divided by separating elements 6 into multiple receiving sections, cf. FIG. 3a. The fed container 5 is subsequently transported by means of transport devices 7, 8 of the filling apparatus into a filling region 3 of the filling apparatus 1, in which the container 5 is filled with banknote stacks 40. After the filling operation, the filling apparatus transports the container 5 filled with banknote stacks 40 by means of a further transport device 9 from the filling region 3 to the delivery interface 4, in the form of a delivery opening, of the filling apparatus, in order to make the container 5 available for manual removal from the filling apparatus 1 or in order for the filled container to be transported away automatically, optionally by means of a conveyor belt. The movement of the container 5 by the filling apparatus is controlled by a control device 80 of the filling apparatus, cf. FIG. 1c.

The gripping device 30 is controlled by a control device 70 and has two gripping elements 31, 32 which are movable away from and toward one another by means of a motor in order to grip the relevant document-of-value stack between the two gripping elements 31, 32. The gripping device 30 grips the banknote stack 40, which has been set down on the mobile platform 22, between its gripping elements 31, 32, cf. FIG. 2a, and removes the banknote stack 40 from the mobile platform 22. By means of a downward pivoting movement (by rotation about the axis A), cf. FIG. 2b, the gripping device 30 moves the banknote stack 40 into a lowered position directly above the filling position 13 of a document-of-value container 5 arranged in the filling region 3, cf. FIG. 2c. Beforehand, that receiving section 6a of the document-of-value container into which the banknote stack is to be introduced has been positioned at the filling position 13, cf. FIGS. 3c and 3f.

The gripping device is subsequently lowered by means of a linear drive 34, cf. FIG. 2c, downward from the lowered position into the receiving section 6a of the document-of-value container, wherein the two gripping elements 31, 32 plunge together with the banknote stack 40 into the receiving section 6a. The lowering movement is stopped and the two gripping elements 31, 32 are opened slightly in order to release the banknote stack 40 and thus set down said banknote stack in the receiving section 6a of the document-of-value container 5, cf. FIG. 3f. The gripping device is subsequently moved upward out of the container 5 again and is available for the introduction of the next banknote stack 40, which is the next to be set down on the mobile platform 22. The introduction of the next banknote stacks into the other receiving sections 6b-f of the document-of-value container 5 is performed analogously.

When the banknote stack 40 is released, the gripping elements 31, 32 are moved apart from one another to an opening width which is equal to or slightly less than the length of the particular receiving section 6a-f along the longitudinal direction of the container 5. The separating elements 6 (see FIG. 3a) provided in the container 5 may, on their side facing toward the introduced banknote stack, have grooves into which the gripping elements 31, 32 can plunge for the purpose of releasing the document-of-value stack, wherein said gripping elements should at most make light contact with said grooves.

To allow document-of-value stacks 40 of different size to be introduced into receiving sections of different size, different opening widths may be provided for the moving-apart of the gripping elements 31, 32 when the particular stack 40 is released. For example, provision may be made whereby receiving sections of several different lengths may be used—in the same or in different containers 5. The control device 70 of the gripping device then controls the moving-apart of the gripping elements 31, 32 such that the opening width when the document-of-value stack is released is adapted to the length of the particular receiving section. The opening width when the stack 40 is released is preferably selected such that the gripping elements 31, 32, as they move apart, do not impact against the separating elements 6 of the container 5. The opening width of the gripping elements may be varied in continuous or discrete fashion. For example, the opening width may be varied continuously by means of a stepper motor for the movement of the gripping elements 31, 32. In this exemplary embodiment, however, a discrete number of opening widths is specified for the gripping device 30 by means of multiple mechanical rams which mechanically limit the moving-apart of the gripping elements 31, 32 when the stack 40 is released, and the position of which is controlled by the control device 70 by means of stop magnets 33, cf. FIG. 2a.

The position of the separating elements 6 along each container 5 may be the same for multiple containers of the same container type and may be predetermined for the particular container type. If different container types are used, the control device 70 has, for example, information relating to the predetermined position of the separating elements 6 or of the receiving sections based on the container type, and optionally relating to the length of the receiving sections, for example in the form of a table. The information required for this purpose and relating to the container type of the container that is to be filled in each case may have been preset at the filling apparatus or may have been input by an operator or may be ascertained automatically by the control device 70 on the basis of identification data of the container 5. The control device 70 then controls the opening width of the gripping elements in accordance with the container type and optionally in accordance with the receiving section that is to be filled in each case (if the container type has receiving sections of different, known sizes).

To determine the identification data of each container 5, the filling apparatus 1 may have, in the region of the feed interface 2, a read device (not shown), for example a barcode reader or QR code reader or RFID reader, which is configured to read in identification data of the container 5 that is fed to the filling apparatus. The identification data of the container may for example be applied to the container in machine-readable form, for example as a numerical sequence or barcode, or may be stored on a transponder that can be read out wirelessly, for example an RFID tag, of the container 5.

If no container type is predetermined or the particular container does not belong to a predetermined container type, the position and length of the receiving sections or of the separating elements of the particular container 5 may however also be determined individually for the particular container 5. For this purpose, the filling apparatus 1 may optionally have, in the feed section 12a, cf. FIG. 3e, one or more light barriers (not shown) which are arranged above the feed section such that a container 5 situated in the feed section can be checked—for example before or as it is transported along the feed section—with regard to the presence and the position of separating elements 6. Then, by calculating the difference between the position coordinates of the separating elements 6 along the longitudinal direction of the container, the control device 70 can ascertain the length of the receiving sections of the container and can control the opening width of the gripping elements 31, 32 accordingly.

Based on the (predetermined or individually ascertained) position of the receiving sections or of the separating elements 6, the control device 70 can for example ascertain receiving section information relating to the length of the receiving sections of the particular container or relating to a maximum number of documents of value for the particular receiving section, and can transmit said receiving section information to the document-of-value processing machine 60. The document-of-value processing machine 60 can then control the quantity of documents of value that it sets down in the delivery region 62 of the document-of-value processing machine in the document-of-value stack 40 for the particular receiving section of the particular container, in accordance with the receiving section information transmitted by the control device 70 and relating to the particular receiving section.

In particular, based on the position of the receiving sections or separating elements, the control device 70 ascertains the length of the receiving sections of the container and, from this, a maximum number of documents of value that the particular document-of-value stack that has been set down on the setting-down platform may have (at a maximum) in order to fit into the particular receiving section 6a-f. For this purpose, a table may be stored in the control device 70, which table specifies the maximum number of documents of value as a function of the length of the receiving sections, for example 20 cm=1000 documents of value, 10 cm=500 documents of value, etc. Alternatively, however, the maximum number of documents of value for the particular stack 40 may also be ascertained by the document-of-value processing machine 60 on the basis of the position of the receiving sections or of the separating elements, or the length of the receiving sections, as transmitted to said document-of-value processing machine.

FIGS. 3a-h incrementally show the horizontal movement of a banknote container 5 through the filling apparatus 1 and the introduction of banknote stacks 40 into the various receiving sections 6a, 6b of the document-of-value container 5. The empty banknote container 5 is firstly fed to the filling apparatus 1 at the feed interface 2, cf. FIGS. 3a and 3b. The first subsection 12a, which begins at the feed interface 2, of the feed section 12a-b is in this case horizontally offset and directly adjacent with respect to the delivery section 14.

In the present exemplary embodiment, the transport device of the filling apparatus 1 has a horizontally movable carriage 7 which is movable at least over a subsection 12a of the feed section along the feed transport direction y (and back again) by means of a drive device. The carriage 7 is designed to receive the container (for example the container base or the container sides). The carriage has for example a planar receptacle, on which the container can be set down, and optionally a stop, against which the set-down container can be pushed in order to bring the container into a defined position relative to the carriage 7. The banknote container 5 is automatically or manually pushed as far as the stop of the carriage 7 and optionally mounted there. The carriage 7 can, optionally by being manually pushed down, be brought into an initial position in which a switch is actuated, which signals to the filling apparatus 1 that the container has been successfully fed in. The control device 80 controls the carriage 7 such that said carriage transports the container 5 along the feed section 12a in the y direction to the document-of-value processing machine 60 until the container 5 engages with a transverse transport bracket 8, cf. FIG. 3c.

The transverse transport bracket 8 is horizontally movable (x direction) transversely or perpendicularly with respect to the feed transport direction by means of a bracket drive device. Said transverse transport bracket is designed to receive one or more side walls of the container. The container is transported by means of the transverse transport bracket 8 along the connecting section 12b, cf. FIG. 3d. The transverse transport bracket 8 subsequently moves back into its initial position again.

After the transverse movement, the container 5 is then transported oppositely to the feed transport direction along the feed section 12c into the filling region 3, and stopped there, by means of a conveyor belt 9, cf. FIG. 3e. Here, the container is positioned such that the receiving section 6a that is to be filled is arranged at the predetermined filling position 13. The banknote stack 40 is then removed from the document-of-value processing apparatus 60 and introduced into the receiving section 6a by means of the gripping device 30, as has been described in conjunction with FIGS. 2a-c, cf. FIG. 3f. Alternatively, instead of the carriage 7 or conveyor belt 9 or transverse transport bracket 8, use may also be made of other transport devices, for example transport rollers or multiple conveyor belts.

The container 5 is subsequently moved onward until the receiving section 6b is positioned at the filling position 13, cf. FIG. 3g. The next banknote stack 40 is then introduced into the receiving section 6b, cf. FIG. 3h, from the document-of-value processing machine 60 as has been described in conjunction with FIGS. 2a-c. The receiving sections 6a-f are thus filled in succession with banknote stacks.

Owing to the incremental transport of the various receiving sections 6a-f to the same filling position 13, the gripping device 30 does not have to move to different filling positions, but can always move to the same predetermined filling position 13 in order to fill the various receiving sections 6a-f. The gripper movement is therefore less complex and therefore has a smaller space requirement. When all or an intended number of receiving sections of the container 5 have been filled, the container 5 is transported in the delivery transport direction (−y) along the delivery section 14 to the delivery interface 4, and can be manually or automatically removed there.

FIGS. 4a-d schematically show various exemplary embodiments of filling apparatuses 1 with differently running transport paths of the containers 5 through the particular filling apparatus 1.

The exemplary embodiment of FIG. 4a has a transport path similar to that in the exemplary embodiment shown in FIGS. 3a-h, with the third feed section 12c however having been omitted. The transport path of the containers from the feed interface 2 to the delivery interface 4 runs continuously substantially horizontally. The first subsection 12a, which begins at the feed interface 2, of the feed section 12a-b is horizontally offset and directly adjacent with respect to the delivery section 14. The connecting section 12b runs, transversely or perpendicularly with respect to the feed transport direction (y) and with respect to the delivery transport direction (−y) of the container, along the operator-facing side of the document-of-value processing machine 60 (−x direction). The filling region 3 is arranged downstream of the connecting section 12b along the transport path. In the filling region 3, the container is filled incrementally as has been described with regard to FIGS. 2 and 3. The return path of the container from the document-of-value processing machine to the delivery interface begins at the filling region 3. The containers 5 are diverted twice in succession horizontally through 90° on their transport path from the feed interface 2 to the delivery interface 4.

It is also the case in the exemplary embodiment from FIG. 4b that the transport path of the containers from the feed interface to the delivery interface runs continuously substantially horizontally. In this case, too, the feed section 12, which begins at the feed interface 2, is arranged so as to be horizontally offset and directly adjacent with respect to the delivery section 14 or the subsection 14b thereof, and the connecting section 14a runs, transversely or perpendicularly with respect to the feed transport direction or with respect to the delivery transport direction of the container, along the operator-facing side of the document-of-value processing machine 60 (x direction). By contrast to the exemplary embodiment in FIG. 4a, the filling region 3 is however arranged upstream of the connecting section 14a along the transport path. The filling region 3 is situated at the end of the forward path of the container from the feed interface 2 to the document-of-value processing machine 60. In this case, too, the containers are diverted twice in succession horizontally through 90° on their transport path from the feed interface 2 to the delivery interface 4 and are filled incrementally in the filling region 3, as has been described with regard to FIGS. 2 and 3.

It is also the case in the exemplary embodiments from FIGS. 4c and 4d that the feed section and the delivery section run at least in part parallel to one another with opposite transport directions. By contrast to the exemplary embodiments from FIGS. 4a and 4b, however, it is the case in the exemplary embodiments of FIGS. 4c and 4d that the feed section 12 or 12a and the delivery section 14b or 14 are at least in part situated vertically one above the other. A more space-saving construction of the filling apparatus 1 in front of the banknote processing machine 60 in a lateral direction (x direction) is thus achieved. Here, the filling region 3 is arranged in the upper region of the filling apparatus 1 or of the vertical arrangement, in order that the gripping device 30 can introduce the banknote stacks into the container 5 from above. The containers 5 are diverted twice in succession, through a total of 180°, on their transport path from the feed interface 2 to the delivery interface 4.

In the exemplary embodiment from FIG. 4c, at least that subsection 12a of the feed section which is situated in the lower region of the filling apparatus 1 is situated under the delivery section 14, with the transport direction running oppositely and parallel thereto. The connecting section 12b of the feed section, in which the transport direction of the container runs vertically or obliquely upward (z direction), connects the lower and the upper region of the filling apparatus. The filling region 3 and the delivery section 14 are situated in the upper region of the filling apparatus. The return path of the container from the document-of-value processing machine 60 to the delivery interface 4 follows the filling region 3. The feed interface 2 is arranged in the lower region of the filling apparatus. Along the transport path, the container passes firstly through the horizontal subsection 12a of the feed section and subsequently through the vertically/obliquely upwardly pointing connecting section 12b, before passing, in the upper region of the filling apparatus, optionally after a further horizontal subsection, into the filling region 3. After the incremental filling operation that is performed there, as described with regard to FIGS. 2 and 3, the container 5 is then transported through the delivery section 14, which is situated above the horizontal subsection 12a of the feed section, and thus to the delivery interface 4.

In the exemplary embodiment from FIG. 4d, the feed section 12 and the filling region 3 are situated in the upper region of the filling apparatus 1, and a connecting section 14a of the delivery section, in which the transport direction of the container runs vertically or obliquely downward (−z direction), connects the upper and the lower region of the filling apparatus. The filling region 3 is situated at the end of the forward path of the container from the feed interface 2 to the document-of-value processing machine 60. A subsection 14b of the delivery section, which subsection follows the connecting section 14a, is situated in the lower region of the filling apparatus and runs under the feed section, with the transport direction running oppositely and parallel thereto. Along the transport path, downstream of the feed interface 2, the container passes, after the feed interface 2, firstly through the horizontally running feed section 12 in the upper region of the filling apparatus 1, before passing, in the upper region of the filling apparatus, into the filling region 3, in which said container is filled incrementally as has been described with regard to FIGS. 2 and 3. Subsequently, optionally after a further horizontal subsection of the delivery section, the container 5 is transported vertically/obliquely downwardly through the connecting section 14a of the delivery section, and then through the horizontal subsection 14b of the delivery section which is situated under the feed section 12, and thus to the delivery interface 4.

1.-15. (canceled)

16. A filling apparatus for filling containers with document-of-value stacks, including document-of-value stacks that have been delivered by a document-of-value processing machine in a delivery region of the document-of-value processing machine,
wherein the containers each have one or more receiving sections which are each designed to receive one document-of-value stack, wherein the filling apparatus has:
a feed interface by means of which the containers that are to be filled with document-of-value stacks are fed to the filling apparatus,
a delivery interface by means of which the containers that have been filled with document-of-value stacks are delivered out of the filling apparatus,
a transport path along which the containers can be transported from the feed interface to the delivery interface,
a filling region in which in each case one container that has been fed to the filling apparatus can be positioned in order to be filled with document-of-value stacks, optionally a gripping device which is configured to grip a document-of-value stack, including a document-of-value stack that has been set down in the delivery region of the document-of-value processing machine, and to set down said document-of-value stack in a receiving section of a container positioned in the filling region of the filling apparatus, in order to fill the container with the document-of-value stack and optionally further document-of-value stacks,
at least one transport device which is designed to transport a container that is fed to the filling apparatus for filling purposes from the feed interface along the transport path to the filling region, and which is designed to transport the filled container, after the filling operation, further along the transport path from the filling region to the delivery interface of the filling apparatus,
a control device which is designed to control the transport of each container along the transport path by means of the transport device,
wherein the control device or optionally a further control device is designed to control the gripping of the document-of-value stack, including the document-of-value stack that has been set down in the delivery region, and the setting-down of the document-of-value stack in the container by means of the gripping device.

17. The filling apparatus according to claim 16, wherein the control device is designed to control the transport device such that a container that is to be filled remains temporarily in the filling region until the gripping device has set down multiple document-of-value stacks into multiple receiving sections of the container.

18. The filling apparatus according to claim 16, wherein the container has at least two receiving sections, and the control device and optionally the further control device is/are designed to control the gripping device and optionally the transport device such that multiple document-of-value stacks that have been delivered by the document-of-value processing machine are set down in succession into different receiving sections of the same container positioned in the filling region.

19. The filling apparatus according to claim 16, wherein the control device is designed
to control the transport device such that in each case one receiving section of a container positioned in the filling region is arranged in a predetermined filling position in the filling region, and
to control the transport device such that each container positioned in the filling region is transported incrementally along a transport direction by means of the transport device such that different receiving sections of the same container are arranged in succession at the predetermined filling position and remain there temporarily until the gripping device has set down in each case one document-of-value stack in the relevant receiving section of the container.

20. The filling apparatus according to claim 16, wherein the transport device has at least one first and at least one second transport device,
wherein the at least one first transport device is designed to transport a container that is fed to the filling apparatus for filling purposes from the feed interface along the transport path to the filling region, and the at least one second transport device is designed to transport the filled container, after the filling operation, further along the transport path from the filling region to the delivery interface of the filling apparatus.

21. The filling apparatus according to claim 16, wherein the the at least one first transport device, is configured to transport each container along a feed transport direction from the feed interface toward the document-of-value processing machine, and the transport device, the at least one second transport device, is configured to transport each container along a delivery transport direction away from the document-of-value processing machine toward the delivery interface.

22. The filling apparatus according to claim 16, wherein the transport path of the containers in the filling apparatus has a feed section, which extends from the feed interface to the filling region, and a delivery section, which extends from the filling region to the delivery interface,
wherein the feed section and the delivery section are arranged in the filling apparatus so as to be mutually separate.

23. The filling apparatus according to claim 16, wherein the feed section or at least a subsection of the feed section, the first subsection that begins at the feed interface, is arranged so as to be vertically and/or horizontally offset, and directly adjacent, with respect to the filling region and/or with respect to the delivery section or at least a subsection of the delivery section, with respect to that subsection of the delivery section which ends at the delivery interface.

24. The filling apparatus according to claim 16, wherein the transport path of the containers in the filling apparatus has a connecting section in which the transport direction of the container runs transversely or perpendicularly with respect to the feed transport direction and/or with respect to the delivery transport direction of the container,
wherein the connecting section runs along the front side of the document-of-value processing machine.

25. The filling apparatus according to claim 16, wherein the transport directions of the container in the feed section and in the delivery section run at least in part oppositely and parallel to one another,
wherein the transport path of the containers in the filling apparatus is designed such that the containers are diverted twice, on their transport path from the feed interface to the delivery interface.

26. The filling apparatus according to claim 16, wherein the transport path of the containers from the feed interface to the delivery interface runs continuously substantially horizontally, and/or
wherein the feed section and the delivery section are at least in part situated horizontally adjacent to one another and run at least in part parallel to one another.

27. The filling apparatus according to claim 16, wherein the feed section and the delivery section are at least in part situated vertically one above the other and run at least in part parallel to one another.

28. The filling apparatus according to claim 16, wherein the filling apparatus, the control device or the further control device, is designed to ascertain receiving section information relating to the receiving sections of the container that is to be filled in each case, said information concerning the position and/or the length of the receiving sections along the container, and optionally to transmit said information to the document-of-value processing machine,
wherein the control device or the further control device is designed to control an opening width of gripping elements of the gripping device in accordance with the receiving section information item during the gripping of the document-of-value stack.

29. A document-of-value processing apparatus for processing documents of value, having
a document-of-value processing machine for processing, documents of value, said document-of-value processing machine being configured to deliver document-of-value stacks of processed documents of value in a delivery region of the document-of-value processing machine, and
a filling apparatus according to claim 16 which is configured for filling containers with the document-of-value stacks that have been delivered out of the document-of-value processing machine.

30. A method for filling containers with document-of-value stacks by means of a filling apparatus, by the filling apparatus according to claim 16,
wherein the filling apparatus has
a feed interface by means of which the containers that are to be filled with document-of-value stacks can be fed to the filling apparatus,
a delivery interface by means of which the containers that have been filled with document-of-value stacks are delivered out of the filling apparatus,
a transport path along which the containers can be transported from the feed interface to the delivery interface,
a filling region which is arranged between the feed interface and the output interface in relation to the transport path of the containers,
at least one transport device which is designed to transport a container that is fed to the filling apparatus for filling purposes from the feed interface along the transport path to the filling region, and which is designed to transport the filled container, after the filling operation, further along the transport path from the filling region to the delivery interface of the filling apparatus,
wherein, in the method, the following steps are carried out:
feeding a container to the feed interface of the filling apparatus,
transporting the fed container by means of the transport device of the filling apparatus from the feed interface along the transport path to the filling region of the filling apparatus,
filling the container positioned in the filling region with at least one document-of-value stack by means of a gripping device which is configured to grip a document-of-value stack and optionally to remove said document-of-value stack from the delivery region of a document-of-value processing machine and to set down said document-of-value stack in a receiving section of the container positioned in the filling region of the filling apparatus, in order to fill the container with the document-of-value stack and optionally further document-of-value stacks,
transporting the container filled with at least one document-of-value stack from the filling region to a delivery interface of the filling apparatus by means of the transport device of the filling apparatus in order to deliver the containers filled with document-of-value stacks out of the filling apparatus through the delivery interface.
